(19) United States
(12) Patent Application Publication
(10) Pub. No.: US 2024/0265803 A1
(43) Pub. Date: Aug. 8, 2024

(54) METHOD, DRIVER ASSISTANCE SYSTEM FOR WIRELESS COMMUNICATION BETWEEN A VEHICLE AND A TRAFFIC INFRASTRUCTURE AND SYSTEM FOR CONTROLLING THE TRAFFIC FLOW

(71) Applicant: ZF CV Systems Global GmbH, Bern (CH)

(72) Inventor: Muthupalaniappan MUTHUPALANIAPPAN, Friedrichshafen (DE)

(21) Appl. No.: 18/433,540

(22) Filed: Feb. 6, 2024

(30) Foreign Application Priority Data
Feb. 6, 2023 (IN) 202311007490

(51) Int. Cl. G08G 1/01; B60K 35/21; G08C 23/04; G08G 1/07; G08G 1/0962; G08G 1/0967

(52) U.S. Cl. CPC G08G 1/0145; B60K 35/21; G08C 23/04; G08G 1/0116; G08G 1/0141; G08G 1/07; G08G 1/09623; G08G 1/096716; G08G 1/096725; B60K 2360/178

(57) ABSTRACT

A method for wireless communication between a vehicle and a traffic infrastructure, including optically outputting information via a digital optical data transmission path in a visible range of light. A driver assistance system for a vehicle includes a control unit for setting an assistance function control signal for a functional unit of the vehicle. The control unit is connected to a receiver module which is configured such that it receives an optical modulated signal which is output from a traffic infrastructure component in a visible range of light over a digital optical data transmission path and converts the received optical modulated signal into a digital code word for further evaluation.

### CROSS REFERENCE TO RELATED APPLICATIONS

This application claims benefit to Indian patent application Ser. No. 20/231,1007490, filed on Feb. 6, 2023, which is hereby incorporated by reference herein.

### FIELD

The invention relates to a method for wireless communication between a vehicle and a traffic infrastructure, a driver assistance system for a vehicle, and a system for controlling a traffic flow of vehicles in road traffic.

### BACKGROUND

There are speed assistance systems (ISA-Intelligent speed assistance system) for vehicles known, which ensure that a speed of the vehicle does not exceed a predetermined value. In the event of a possible speed exceeding, the driver is warned, or the speed of the vehicle is automatically reduced. To recognize a corresponding traffic sign, the speed assistance system uses a camera perceived speed sign information and also the GPS-data consisting speed sign information present in a specific route the vehicle is travelling. In “LiFi is a paradigm-shifting 5G technology” review in Physics 3 (2018) 26-31, Light-Fidelity (LiFi) technology is described as wireless communication technology that can be used in the infrared and visible light spectrum for fast data communication.

The article “6G for Vehicle-to-Everything (V2X) Communications: Enabling Technologies, Challenges and Opportunities” arXiv: 2012.07753v1 [cs.IT] 14 Dec. 2020 reveals the use of LiFi technology for V2X communication.

### SUMMARY

In an embodiment, the present disclosure provides a method for wireless communication between a vehicle and a traffic infrastructure, comprising optically outputting information via a digital optical data transmission path in a visible range of light.

In an embodiment, the present disclosure provides a driver assistance system for a vehicle comprises a control unit for setting an assistance function control signal for a functional unit of the vehicle. The control unit is connected to a receiver module which is configured such that it receives an optical modulated signal which is output from a traffic infrastructure component in a visible range of light over a digital optical data transmission path and converts the received optical modulated signal into a digital code word for further evaluation.

In an embodiment, the present disclosure provides a system for controlling a traffic flow of vehicles in road traffic, comprising permanently installed roadside devices for optical output of information which are detectable by the vehicles, and receiver modules located on the vehicles. The roadside permanently installed devices are configured as lighting units such that they output in a visible range of light via an optical data transmission path the information comprising an optical modulated signal, the optical modulated signal being sent to one or more of the vehicles. The receiver modules of the one or more of the vehicles to which the optical modulated signal is sent detects the optical modulated signal and converts it into a digital code word from which the information is derived and used to control the vehicle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic representation of a system according to an embodiment of the invention;

FIG. 2 illustrates a schematic representation of a driver assistance system according to an embodiment of the invention; and

FIG. 3 illustrates a schematic representation of a system according to an embodiment of the invention.

### DETAILED DESCRIPTION

In an embodiment, the present invention provides a method, a driver assistance system and a system for controlling a traffic flow, which enables fast wireless data exchange between vehicles and a traffic infrastructure by simple means.

A method for wireless communication between a vehicle and a traffic infrastructure, in which information is output by optical means comprises that the wireless communication takes place via a digital optical data transmission path in the visible range of light.

In an embodiment, a driver assistance system for a vehicle is provided, comprising a control unit for setting an assistance function control signal for a functional unit of the vehicle. The control unit is connected to a receiver module which is designed such that it receives an optical modulated signal which is output from a traffic infrastructure in the visible range of light over a digital optical data transmission path and converts the received optical modulated signal into a digital code word signal for further evaluation.

In an embodiment, a system is provided for controlling a traffic flow of motor vehicles in road traffic, comprising permanently installed roadside devices for optical output of information which are detectable by the vehicles. The roadside permanently installed devices are designed as lighting units such that they in a visible range of light via an optical data transmission path transmit the information comprising an optical modulated signal to the vehicle, which detects this optical modulated signal by a receiver module located on the vehicle and converts it into a digital code word from which the information is derived and used to control the vehicle.

In all applications, LiFi module is installed in a roadside infrastructure. This roadside infrastructure can be, for example, a pole with an LED light source or a streetlamp or traffic light that can serve as a source for transmitting LiFi signals. Due to the fixed installation of the sources for LiFi signals in the traffic infrastructure, sensor dependencies and their placement on the vehicle as well as the dependence on the quality of a GPS signal and the weather are eliminated. The vehicles only have to enter the detection area of the LiFi source. Since the vehicles only need one receiver for the LiFi signals and a corresponding evaluation unit, the technical equipment expenditure on the vehicle is reduced, which reduces costs. The reliability of the optically modulated signal is thus increased.

In a preferred embodiment the optical modulated signal is a pulse-coded modulated light signal, in particular a pulse-position modulation technique.

In particular, the light signal emitted via the digital optical data transmission path is binary encoded. The binary coding allows the receiver module of the light signal a reliable evaluation. Binary coding is easy to implement as the lighting unit only needs to be switched off or on at specific time intervals.

The optically modulated signal, which is emitted by the source of the LiFi signal, can correspond to a traffic sign, which is transmitted in optically modulated form to the vehicle and evaluated in it. Digital code words for different traffic signs can be stored in each LiFi source, so that different traffic signs can be transmitted one after the other. For example, a traffic sign indicating a speed limit can be replaced by a traffic sign indicating a traffic jam, if the local traffic situation it requires.

In an embodiment, the digital code words for various traffic signs are managed in a central traffic management system and the relevant digital code words characterizing a traffic sign are transmitted wirelessly targeted to the specified lighting unit, which converts the digital code word into a pulse-code modulated signal for controlling the lighting unit by means of a light control module. By managing the codes for the different traffic signs in a central database of the traffic management system, it is possible to react dynamically to changing traffic conditions and to adapt the traffic signs in a large area to the current traffic situation.

In an embodiment the traffic sign to be coded is a speed limit. By changing a speed limit, which is detected by the vehicle approaching, the traffic flow can be reliably controlled at different traffic volumes, which can prevent traffic jams.

A particularly simple method comprises that the pulse-code signal received by the vehicle via the optical data transmission path in the vehicle for recognizing the traffic sign is evaluated and the driving behavior of the vehicle is automatically adapted to the specification of the traffic sign. A particular advantage is that the speed limit detected in the vehicle is automatically implemented in the vehicle and the vehicle speed is adapted to the displayed speed limit without driver intervention.

An embodiment of the invention relates to a driver assistance system for a vehicle, comprising a control unit for setting an assistance function control signal for a functional unit of the vehicle. The control unit is connected to a receiver module which is designed such that it receives an optical modulated signal which is output from a traffic infrastructure in the visible range of light over a digital optical data transmission path and converts the received optical modulated signal into a digital code word for further evaluation. The optical modulated signal is output by the LiFi unit permanently installed on the roadside infrastructure. With the help of the receiver unit, the driver assistance system recognizes a traffic sign transmitted by the LiFi signal when entering the transmission range of the LiFi unit. When using the LiFi receiver in an intelligent speed assistance system called ISA system, a speed limit can be implemented with little hardware effort.

With the auxiliary function control signal or several assistance function control signals, the driver assistance system controls other components of the vehicle in order to implement the assistance function, such as traffic sign recognition. The other components may be included in the driver assistance system or be equipped with regard to the system architecture of the vehicle with separate and/or independent modules, such as an engine control unit.

The aspects described here with reference to the method apply equally to the disclosed driver assistance system, which can be carried out, for example, by a central control unit. This can be done by making suitable write and read accesses to a memory assigned to the vehicle, in which, for example, the currently recognized traffic signs are stored. The hardware of the driver assistance system includes in particular digital signal processors, application-specific integrated circuits, field programmable gate arrays and other suitable switching and computing components.

In an embodiment the lighting units comprise a light control module which is designed to convert a digital code word characterizing a traffic sign into a control signal for the lighting unit for the output of the optical modulated signal. The constructive effort for the formation of the system is therefore limited, since a correspondingly programmed microprocessor can be used as a lighting control module.

Especially, if the light control module of the lighting unit is wirelessly coupled to a central traffic management system for transmitting a digital code word corresponding to the traffic sign a lot of different traffic signs can be transmit to the lighting unit by sending different optical modulated signals to the vehicles.

This system allows comprehensive coverage of an area by dynamically changing traffic signs recognized by passing vehicles. For example, the announcement and marking of construction sites can be largely dispensed with, since only by changing the optically modulated signal emitted by the LiFi unit, the traffic sign for a construction site is transmitted to the vehicle without having to set up individual traffic signs at the roadside. After completion of the construction site, this optically modulated signal only needs to be deleted or replaced by an optically modulated signal representing another traffic sign.

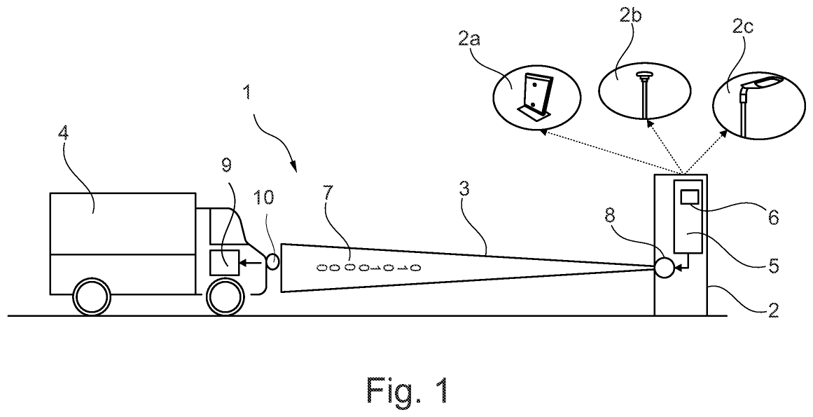

A system 1 according to an embodiment of the invention for controlling a traffic flow of motor vehicles in road traffic is shown in FIG. 1. Along the roadside, lighting units 2 for the optical output of information via a digital optical data transmission path 3 are permanently installed at predetermined intervals, which are detected by passing vehicles 4 entering the area of the data transmission path 3. As such lighting units 2 can be used, for example, existing on the roadside guardrails 2a, lampposts 2b or streetlamps 2c. Each lighting unit 2 comprises a lighting control module 5 in which a memory 6 is arranged. In the memory 6, various digital code words 19 are stored, each representing a predetermined traffic sign. To output a desired traffic sign, the corresponding code word is read out by the light control module 5 from the memory 6. The light control module 5 controls the lighting device 2 so that the digital code word 19 is output as an optically modulated light signal 7 from an LED 8 of the lighting device 2 in the visible region of the spectrum to the environment.

Advantageously, the optically modulated light signal 7 represents a binary signal. To emit the binary signal, LED 8 must be switched on and off at specified intervals.

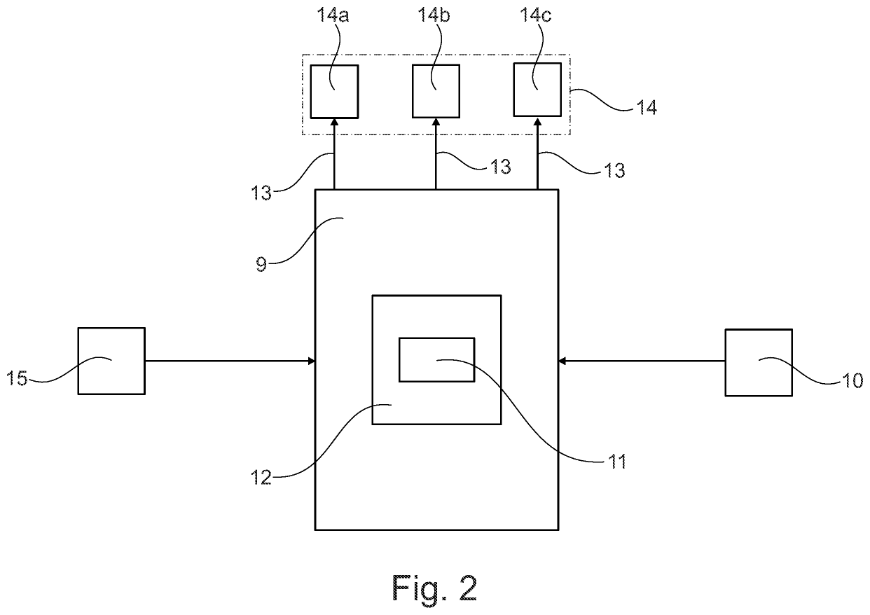

These optically modulated signals 7 are received by the vehicles 4, which enter the radiation range of the lighting units 2. In order to be able to evaluate the optically modulated signals, the vehicle 4 comprises a driver assistance system 9, as shown in FIG. 2. The driver assistance system 9 comprises a receiver module 10 designed as a photoelement for receiving the optically modulated signal 7. The receiver module 10 converts the optically modulated signal 7 into an adequate digital code word. This digital code word is fed to a decoding module 11, which assigns it to a corresponding traffic sign. Depending on the recognized traffic sign, a control unit 12 comprising the decoding module 11 generates an assistance function control signal 13, which controls a vehicle operating unit 14 to adapt the driving behavior of the vehicle 4 to the traffic sign. At least one vehicle sensor 15 measures the current driving characteristics like vehicle velocity.

The traffic sign transmitted by optical modulation can, for example, be a speed limit sign. A speed limit of 80 km/h can be encoded as a binary signal 0101 0000. In order to set this speed limit automatically in the vehicle 4, the control unit 12 of the driver assistance system 9 evaluates the current vehicle speed measured by vehicle sensors 15. Depending on whether the current vehicle speed is greater or less than the specified 80 km/h, the assistance function control signal is output either to a braking system 14a or an engine control system 14b of the vehicle 4, each of which forms a vehicle operating unit 14. Alternatively, a display 14c can indicate a warning signal to the driver, which then manually acts on the vehicle operating unit 14a, 14b to adjust the speed limit.

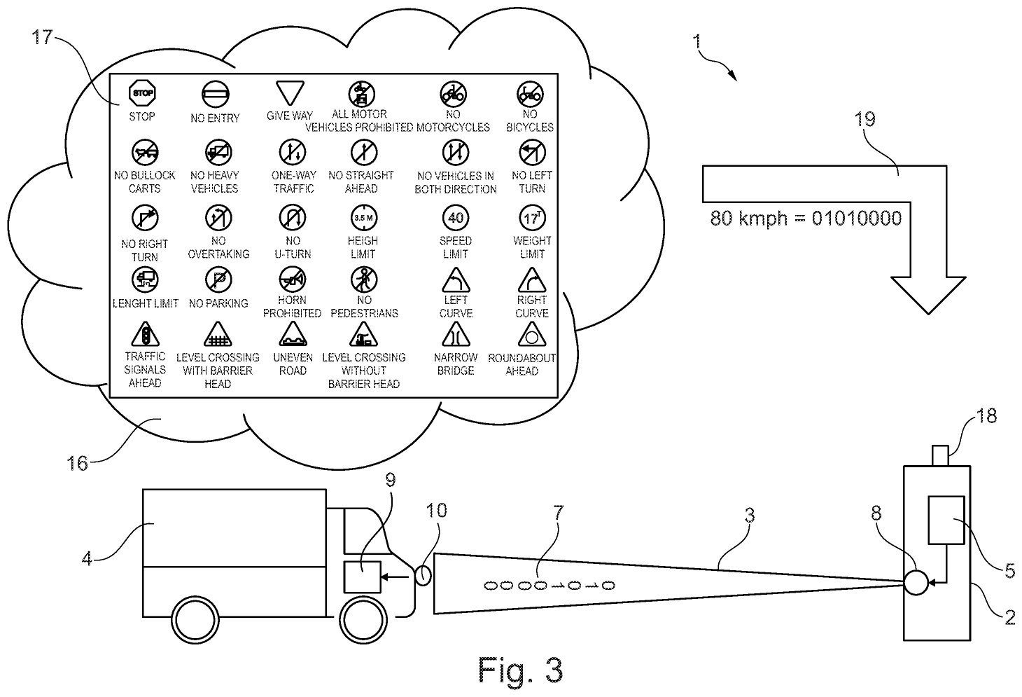

Depending on the current volume of traffic and/or weather conditions and/or construction sites, in the area of the lighting unit 2 the speed limit can be dynamically adjusted with the aid of a central traffic management system 16, as shown in FIG. 3. The speed limit can be reduced, for example to 50 km/h. For this purpose, a modulated light signal 7 with another binary coding, for example 0011 0010, is output from the lighting unit 2.

The central traffic management system 16 monitoring the traffic situation manages a plurality of traffic signs in a database 17, wherein each traffic sign is assigned a specific digital code word 19. Depending on the traffic situation, a traffic sign is selected, the digital code word 19 of which is sent wirelessly, preferably by radio, to the relevant lighting unit 2. A radio receiver 18 of the lighting unit 2 is coupled to the light control module 5, which controls the lighting unit 2 depending on the received digital code word 19 to output a corresponding optically modulated light signal 7. The evaluation of the optically modulated light signal 7 received by the vehicle 4 is carried out in vehicle 4 in the manner described in connection with FIG. 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 system
2 lighting unit
2a guardrails
2b lamppost
2c streetlight
3 digital optical data transmission path
4 vehicle
5 light-control module
6 memory
7 optically modulated light signal
8 LED
9 driver assistance system
10 receiver module
11 decoding module
12 control unit
13 assistance function control signal
14 vehicle operating unit
14a brake system
14b engine control unit
14c display
15 vehicle sensor
16 central vehicle management system
17 database for traffic signs
18 radio receivers
19 digital code word for traffic signs

1. A method for wireless communication between a vehicle and a traffic infrastructure, comprising:
optically outputting information via a digital optical data transmission path in a visible range of light.

2. The method according to claim 1, further comprising transmitting via the digital optical data transmission path a modulated optical signal representing a traffic sign as a pulse-code modulated signal to the vehicle entering the transmission path.

3. The method according to claim 2, wherein the optical modulated signal representing the traffic sign is output from a roadside permanently installed lighting unit of the traffic infrastructure as the pulse-code modulated signal.

4. The method according to claim 3, wherein a plurality of digital code words for traffic signs are stored in a light control module of the lighting unit.

5. The method according to claim 4 wherein the plurality of digital code words for various traffic signs are managed in a central traffic management system and a relevant digital code word characterizing a respective traffic sign is transmitted wirelessly targeted to the lighting unit, which converts the digital code words into the pulse-code modulated signal for controlling the lighting unit by the light control module.

6. The method according to claim 2, wherein the traffic sign to be transmitted is dynamically adapted depending on a traffic situation.

7. The method according to claim 2, wherein the traffic sign is a speed limit.

8. The method according to claim 2, further comprising evaluating the pulse-code signal received by the vehicle via the optical data transmission path for recognizing the traffic sign and automatically adapting a driving behavior of the vehicle to a specification of the traffic sign.

9. A driver assistance system for a vehicle, comprising:
a control unit for setting an assistance function control signal for a functional unit of the vehicle,
wherein the control unit is connected to a receiver module which is configured such that it receives an optical modulated signal which is output from a traffic infrastructure component in a visible range of light over a digital optical data transmission path and converts the received optical modulated signal into a digital code word for further evaluation.

10. The driver assistance system according to claim 9, wherein the receiver module, when entering a transmission range from a roadside permanently installed lighting unit starts monitoring the optical data transmission path for receiving the pulse-code modulated optical signal output from the lighting unit.

11. The driver assistance system according to claim 9, wherein the control unit comprises a recognition unit which is configured such that it retrieves a traffic sign characterized by the optical modulated signal and derives the assistance function control signal for adapting a driving behavior of the vehicle to the traffic sign.

12. The driver assistance system according to claim 11, wherein the receiver module comprises a photoelement for detecting the transmitted optical modulated signal and for conversion of the optical modulated signal into a digital code word, which is entered into the recognition unit of the control unit.

13. The driver assistance system according to claim 11, wherein the recognition unit is configured to recognize the traffic sign characterized by the optical modulated signal as a speed limit and provides the assistance function control signal for a drive or brake functional unit of the vehicle to adapt the driving behavior of the vehicle to the recognized traffic sign and/or for a display as a dashboard warning for a driver, whereby a current driving characteristic is measured by at least one vehicle sensor.

14. A system for controlling a traffic flow of vehicles in road traffic, comprising:
permanently installed roadside devices for optical output of information which are detectable by the vehicles; and
receiver modules located on the vehicles,
wherein the roadside permanently installed devices are configured as lighting units such that they output in a visible range of light via an optical data transmission path the information comprising an optical modulated signal, the optical modulated signal being sent to one or more of the vehicles, and
wherein the receiver modules of the one or more of the vehicles to which the optical modulated signal is sent detects the optical modulated signal and converts it into a digital code word from which the information is derived and used to control the vehicle.

15. The system according to claim 14, wherein the lighting units comprise a light control module which is configured to convert the digital code word characterizing a traffic sign into a control signal for the lighting units for output of the optical modulated signal.

16. The system according to claim 15, wherein the light control module of the lighting units are wirelessly coupled to a central traffic management system for transmitting the digital code word corresponding to the traffic sign.
